(19) United States
(12) Patent Application Publication
(10) Pub. No.: US 2012/0269900 A1
(43) Pub. Date: Oct. 25, 2012

(54) COMPOSITIONS AND METHODS FOR A BUG REPELLENT

(76) Inventor: D. Tobin Watkinson, La Jolla, CA (US)

(21) Appl. No.: 13/274,228

(22) Filed: Oct. 14, 2011

Related U.S. Application Data
(60) Provisional application No. 61/393,292, filed on Oct. 14, 2010.

(51) Int. Cl. A01N 59/16; A01P 17/00; A01N 59/00; A01N 59/06

(52) U.S. Cl. 424/646; 424/684; 424/600

(57) ABSTRACT

The present invention relates to compositions and methods for deterring and repelling all types of organisms capable of sensing electric or magnetic fields, including insects and arachnids. The compositions contain electrically or magnetically imprintable substances comprising an electric or magnetic charge or imprint, wherein the imprint contains the signature of at least one target organism; and an acceptable carrier.

### CROSS REFERENCE TO RELATED APPLICATIONS

This application claims the benefit of Provisional Application No. 61/393,292 filed on Oct. 14, 2010, which is incorporated herein by reference in its entirety.

### BACKGROUND OF THE INVENTION

Pests, which are organisms detrimental to humans or human concerns, are capable of destroying crops, injuring people, and transmitting deadly diseases. One example of the potential destruction that can be attributable to pest include damage caused by arthropod pests, which has been estimated to cause a 10% to 15% loss in agricultural production in the United States. Also, up to an additional loss of 40% can be inflicted by these same pests after crops are harvested. Arthropod pests have also been shown to transmit to humans various types of diseases, including virus, bacterial and protozoal diseases. Recently, Lyme disease has emerged as the most common tick-borne disease in the Northern Hemisphere. Lyme disease, or Lyme borreliosis, is an infectious disease caused by at least three species of Borrelial bacteria. Ticks, such as deer tick, are carriers of the disease, passing the Borrelial bacteria through its bite and saliva. Left untreated, Lyme disease may involve the joints, heart, and central nervous system. Delayed or inadequate treatment can lead to possibly disabling and difficult to treat symptoms, or even death.

Chemical-based insect repellents are available that can be applied to skin, clothing, or in the immediate surroundings of a person. The EPA has registered a number of chemical-based insect repellents, most notably DEET (N,N-diethyl-meta-toluamine or N,N-diethyl-3-methyl-benzamide) which is estimated to be used by one-third of the United States population. Despite such wide use, there are concerns about the negative impact of DEET and other chemicals present in insect repellents. Many of these products have been known to contain chemicals that are harmful to humans and animals. Some are even known carcinogens and others are highly toxic and can be found in the bloodstream of users of such products. Chemical pesticides used on crops, such as DDT (dichlorodiphenyltrichloroethane), are effective, but have also been found to have a negative effect on humans and the environment.

### SUMMARY OF THE INVENTION

Compositions and methods for deterring and repelling pests are disclosed.

Disclosed herein, in certain embodiments, are compositions comprising: an electrically or magnetically imprintable substance comprising an electric or magnetic imprint, wherein said imprint is a modified electric or magnetic signature derived from at least one target organism; and an acceptable carrier. In some embodiments, the compositions disclosed herein alter the detectable electrical properties of a subject, object or structure to which they are applied. In some embodiments, the composition, when applied to a subject, object or structure, alters the electric field of the subject, object or structure. In further embodiments, the composition, when applied to a subject, object or structure, decreases the electric field of the subject, object or structure. In further embodiments, the composition, when applied to a subject, object or structure, alters the electrical impedance of the subject, object or structure. In further embodiments, the composition, when applied to a subject, object or structure, increases the electrical impedance of the subject, object or structure. In some embodiments, the electrically or magnetically imprintable substance is a mineral, mineral powder, or mineral solution. In some embodiments, the mineral comprises at least one gemstone. In some embodiments, the mineral comprises at least one metallic substance. In some embodiments, the mineral comprises at least one or more of: carbon, sodium, magnesium, potassium, calcium, and sulfur. In some embodiments, the mineral comprises iron. In some embodiments, the mineral solution is an aqueous solution. In some embodiments, the mineral solution is a silicate mineral solution. In further embodiments, the silicate mineral solution is a clay mineral solution. In still further embodiments, the clay mineral solution is a kaolinite mineral solution. In some embodiments, the carrier is substantially water. In some embodiments, the electric or magnetic signature is derived from one target organism, target organism species, target organism genus, or target organism class. In other embodiments, the signature is derived from a plurality of target organisms, target organism species, target organism genuses, or target organism classes. In some embodiments, the at least one target organism is chosen from the group consisting of: insecta, arachnida, gastropoda, nematoda, and annelida. In further embodiments, the at least one target organism is chosen from the group consisting of: ticks, mosquitoes, flies, gnats, chiggers, spiders, mites, cockroaches, bedbugs, lice, bees, stinkbugs, and ants. In some embodiments, the modification of the electric or magnetic signature is selected from: inversion, phase shift, polarity shift, reversal, amplification, and duplication. In further embodiments, the modification of the electric or magnetic signature is inversion. In some embodiments, the composition is a topical composition. In further embodiments, the topical composition is a liquid, lotion, cream, aerosol, spray, ointment, hydrogel, paste, soap, patch, or wipe. In still further embodiments, the topical composition further comprises one or more of: a lubricant, thickener, emollient, moisturizer, spreading agent, and rheology modifier.

Also disclosed herein, in certain embodiments, are methods to repel or deter at least one target organism, the method comprising: administering a composition comprising an electrically or magnetically imprintable substance comprising an electric or magnetic imprint, wherein said imprint is derived from the at least one target organism; and an acceptable carrier. In some embodiments, the composition is administered via application to a subject. In some embodiments, the application is topical. In various embodiments, the subject is a human, a non-human animal, a plant, a field or crop of plants, and the like. In other embodiments, the composition is applied to an object or a structure. In some embodiments, the object or structure is associated with or surrounding one or more humans, non-human animals, or plants. In some embodiments, the composition, when applied to a subject, object or structure, alters the electric field of the subject, object or structure. In further embodiments, the composition, when applied to a subject, object or structure, decreases the electric field of the subject, object or structure. In some embodiments, the composition, when applied to a subject, object or structure, alters the electrical impedance of the subject, object or structure. In further embodiments, the composition, when applied to a subject, object or structure, increases the electrical impedance of the subject, object or structure. In some embodiments, the composition is applied to a subject such that the electric field of the subject is reduced, obscured, or masked. In some embodiments, the composition is applied to an object or a structure associated with or surrounding a subject such that the electric field of the object or structure is reduced, obscured, or masked.

In some embodiments, the electrically or magnetically imprintable substance is a mineral, mineral powder, or mineral solution. In some embodiments, the mineral comprises at least one gemstone. In some embodiments, the mineral comprises at least one metallic substance. In some embodiments, the mineral comprises one or more of: carbon, sodium, magnesium, potassium, calcium, and sulfur. In some embodiments, the mineral comprises iron. In some embodiments, the mineral solution is an aqueous solution. In some embodiments, the mineral solution is a silicate mineral solution. In further embodiments, the silicate mineral solution is a clay mineral solution. In still further embodiments, the clay mineral solution is a kaolinite mineral solution. In some embodiments, the carrier is substantially water. In some embodiments, the electric or magnetic imprint is derived from one target organism, target organism species, target organism genus, or target organism class. In other embodiments, the imprint is derived from a plurality of target organisms, target organism species, target organism genuses, or target organism classes. In some embodiments, the at least one target organism is chosen from the group consisting of: insecta, arachnida, gastropoda, nematoda, and annelida. In further embodiments, the at least one target organism is chosen from the group consisting of: ticks, mosquitoes, flies, gnats, chiggers, spiders, mites, cockroaches, bedbugs, lice, bees, stinkbugs, and ants. In some embodiments, the electric or magnetic imprint is derived from the electric or magnetic signature of the at least one target organism and subsequently modified. In further embodiments, the modification of the electric or magnetic signature is selected from: inversion, reversal, phase shift, polarity shift, amplification, and duplication. In further embodiments, the modification of the electric or magnetic signature is inversion. In some embodiments, the composition is a topical composition. In further embodiments, the topical composition is a liquid, lotion, cream, aerosol, spray, ointment, hydrogel, paste, soap, patch, or wipe.

Also disclosed herein, in certain embodiments, are methods of formulating a composition to repel at least one target organism comprising: combining an electrically or magnetically imprintable substance comprising an electric or magnetic imprint, wherein said imprint is a modification of an electric or magnetic imprint derived from at least one target organism, and an acceptable carrier. In some embodiments, the formulation is a topical formulation. Such topical formulations may include, but are not limited to, aerosols, sprays, ointments, creams, hydrogels, lotions, and pastes. In some embodiments, the composition, when applied to a subject, object or structure, decreases the electric field of the subject, object or structure. In some embodiments, the composition, when applied to a subject, object or structure, increases the electrical impedance of the subject, object or structure. In some embodiments, the electrically or magnetically imprintable substance is a mineral or a mineral solution. In some embodiments, the mineral comprises at least one gemstone. In some embodiments, the mineral comprises at least one metallic substance. In some embodiments, the mineral comprises one or more of: sodium, magnesium, potassium, calcium and sulfur. In other embodiments, the mineral solution comprises a metallic substance. In some embodiments, the mineral solution comprises one or more of: sodium, magnesium, potassium, calcium, and sulfur. In some embodiments, the mineral solution comprises iron. In some embodiments, the mineral solution is an aqueous solution. In some embodiments, the mineral solution is a silicate mineral solution. In further embodiments, the silicate mineral solution is a clay mineral solution. In still further embodiments, the clay mineral solution is a kaolinite mineral solution. In some embodiments, the carrier is substantially water. In some embodiments, the electric or magnetic imprint is derived from one target organism, target organism species, target organism genus, or target organism class. In other embodiments, the imprint is derived from a plurality of target organisms, target organism species, target organism genuses, or target organism classes. In some embodiments, the at least one target organism is chosen from the group consisting of: insecta, arachnida, gastropoda, nematoda, and annelida. In further embodiments, the at least one target organism is chosen from the group consisting of: ticks, mosquitoes, flies, gnats, chiggers, spiders, mites, cockroaches, bedbugs, lice, bees, stinkbugs, and ants. In some embodiments, the modification of the electric or magnetic imprint is selected from: inversion, phase shift, reversal, amplification, and duplication. In further embodiments, the modification of the electric or magnetic imprint is inversion.

Also disclosed herein, in certain embodiments, are methods of manufacturing a composition to repel at least one target organism comprising: 1) obtaining a library of electric and/or magnetic signals or signatures from at least one target organism; 2) inverting and/or modifying the electric or magnetic signal or signature of the at least one organism; 3) imprinting the inverted and/or modified electric or magnetic signal or signature on an electrically or magnetically imprintable substance; and 4) combining with an acceptable carrier. In some embodiments, the electrically or magnetically imprintable substance is a mineral, mineral powder, or mineral solution. In some embodiments, the mineral comprises at least one gemstone. In some embodiments, the mineral comprises at least one metallic substance. In some embodiments, the mineral comprises one or more of: carbon sodium, magnesium, potassium, calcium, and sulfur. In some embodiments, the mineral comprises iron. In some embodiments, the mineral solution is an aqueous solution. In some embodiments, the mineral solution is a silicate mineral solution. In further embodiments, the silicate mineral solution is a clay mineral solution. In still further embodiments, the clay mineral solution is a kaolinite mineral solution. In some embodiments, the carrier is substantially water. In some embodiments, the electric or magnetic imprint is derived from one target organism, target organism species, target organism genus, or target organism class. In other embodiments, the imprint is derived from a plurality of target organisms, target organism species, target organism genuses, or target organism classes. In some embodiments, the at least one target organism is chosen from the group consisting of: insecta, arachnida, gastropoda, nematoda, and annelida. In further embodiments, the at least one target organism is chosen from the group consisting of: ticks, mosquitoes, flies, gnats, chiggers, spiders, stinkbugs, mites, bedbugs, lice, bees and ants. In some embodiments, the modification of the electric or magnetic imprint is selected from: inversion, phase shift, reversal, amplification, and duplication. In further embodiments, the modification of the electric or magnetic imprint is inversion. In some embodiments, the composition is a topical composition. In further embodiments, the topical composition is a liquid, lotion, cream, aerosol, spray, ointment, hydrogel, or paste. In still further embodiments, the topical composition further comprises one or more of: a lubricant, thickener, emollient, moisturizer, spreading agent, and rheology modifier.

Also disclosed herein, in certain embodiments, are methods of manufacturing a composition to reduce, prevent or deter bug bites. In some embodiments, this method includes the steps of: 1) obtaining a library of bug electric and/or magnetic signals or signatures; 2) inverting and/or modifying the electric or magnetic signal or signature; and 3) imprinting the inverted electric or magnetic signal or signature on an electrically or magnetically imprintable substance.

Also disclosed herein, in certain embodiments, are methods of manufacturing a composition to reduce or prevent bug bites and treating an individual with an injectable composition, oral composition, or a topical composition. In some embodiments, the composition is a topical composition. Such topical compositions may include but are not limited to an aerosol, a spray, an ointment, a cream, a hydrogel or a lotion. In a preferred embodiment, the composition includes a mineral solution. The mineral solution may contain iron. In some embodiments of the present invention, the bugs are chosen from the group consisting of: ticks, mosquitoes, flies, gnats, chiggers, spiders, mites, bedbugs, lice, bees and ants.

Also disclosed herein, in certain embodiments, are methods to reduce or prevent bug bites, the method comprising administering to an individual in need thereof a composition to reduce or prevent bug bites, the composition comprising an electrically or magnetically imprintable substance comprising an electric or magnetic imprint, wherein said imprint is a modification of an electric or magnetic imprint derived from at least one target organism; and an acceptable carrier.

Also disclosed herein, in certain embodiments, are methods to reduce or prevent bug bites on individual with an injectable composition, oral composition, or a topical composition. In some embodiments, the composition is a topical composition. Such topical compositions may include, but are not limited to, aerosols, sprays, ointments, creams, hydrogels, lotions, and pastes. In a preferred embodiment, the electrically or magnetically imprintable substance is a mineral or a mineral solution. In further embodiments, the mineral contains iron. In some embodiments of the present invention, the bugs are chosen from the group consisting of: ticks, mosquitoes, flies, gnats, chiggers, spiders, mites, bedbugs, lice, bees and ants.

Also disclosed herein, in a particular embodiment, is a composition comprising an electrically or magnetically imprintable substance comprising an electric or magnetic imprint, wherein said imprint is an inversion of an electric or magnetic imprint derived from a plurality of ticks; and an acceptable carrier.

Further disclosed herein, in certain embodiments, are methods of formulating said composition to reduce or prevent tick bites and treating an individual with an injectable composition, oral composition, or a topical composition. In some embodiments, the composition is a topical composition. Such topical compositions may include but are not limited to aerosols, sprays, ointments, creams, hydrogels, and lotions. In a preferred embodiment, the electrically or magnetically imprintable substance is a mineral solution. The mineral solution may contain iron.

Also disclosed herein, in certain embodiments, are methods of manufacturing a composition to reduce or prevent tick bites. In some embodiments, this method includes the steps of: 1) obtaining a library of electric and/or magnetic signals from ticks; 2) inverting and/or modifying the electric or magnetic signal of the ticks; and 3) imprinting the inverted electric or magnetic signal on an electrically or magnetically imprintable substance.

Also disclosed herein, in certain embodiments, are methods of manufacturing a composition to reduce or prevent tick bites and treating an individual with an injectable composition, oral composition, or a topical composition. In some embodiments, the composition is a topical composition. Such topical compositions may include but are not limited to an aerosol, a spray, an ointment, a cream, a hydrogel or a lotion. In a preferred embodiment, the electrically or magnetically imprintable substance is a mineral solution. The mineral solution may contain iron.

Also disclosed herein, in certain embodiments, are methods to reduce or prevent tick bites, the method comprising administering to an individual in need thereof a composition to reduce or prevent tick bites, the composition comprising a modified electric or magnetic imprint of a plurality of ticks and an acceptable carrier.

Also disclosed herein, in certain embodiments, are methods of formulating a composition to reduce or prevent tick bites and treating an individual with an injectable composition, oral composition, or a topical composition. In some embodiments, the composition is a topical composition. Such topical compositions may include but are not limited to an aerosol, a spray, an ointment, a cream, a hydrogel or a lotion. In a preferred embodiment, the acceptable carrier is a mineral solution. The mineral solution may contain iron.

Disclosed herein, in one particular embodiment, is a composition comprising: an electrically or magnetically imprintable, iron-containing mineral comprising an electric or magnetic imprint, wherein said imprint is an inversion of an electric or magnetic signature derived from a plurality of ticks; and a water-based carrier formulated for topical treatment.

### BRIEF DESCRIPTION OF FIGURES

FIG. 1 is a graphical representation of the toxicity of active ingredients in popular tick repellent products.

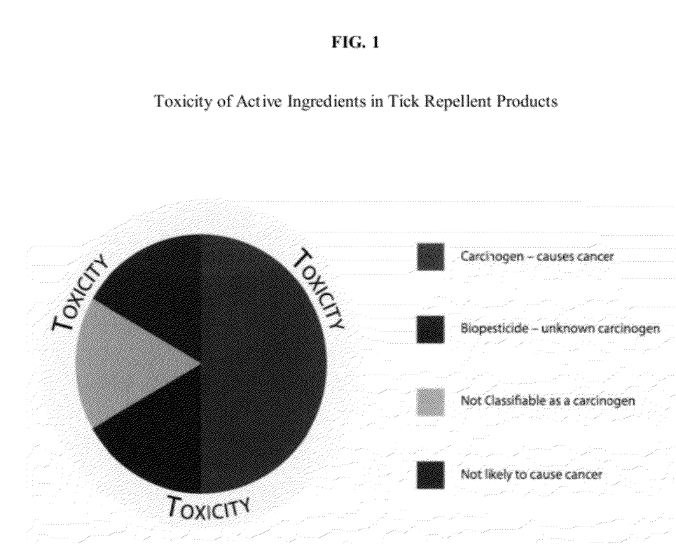

FIG. 2 is a graph showing the number of confirmed cases of Lyme disease in Massachusetts, Maine, Connecticut, and New Hampshire by counties in 2008.

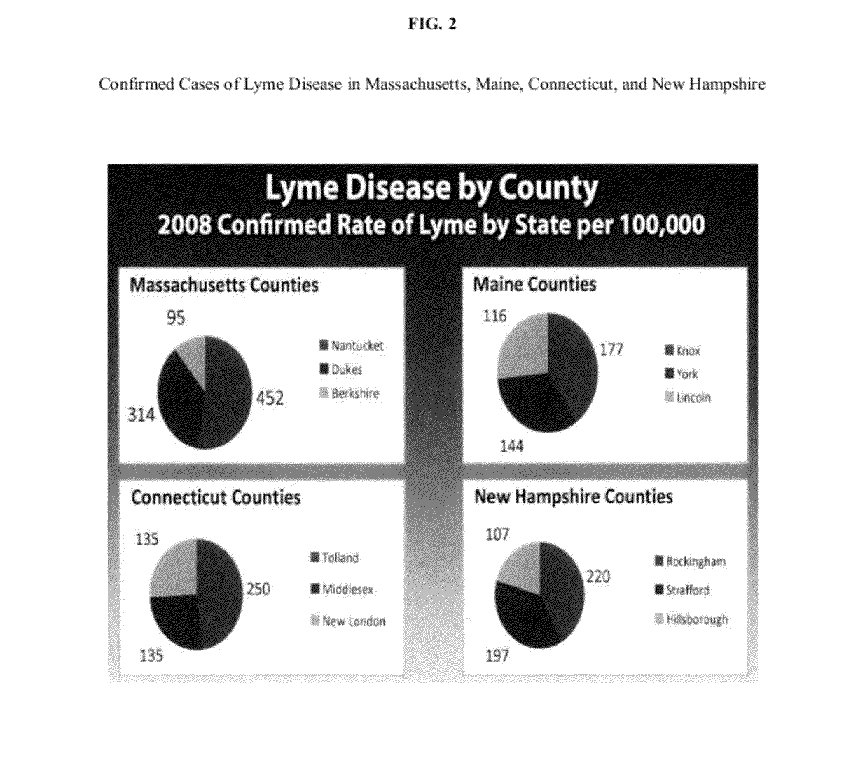

FIG. 3 is a graphical representation of independent predictions of the growth of Lyme disease.

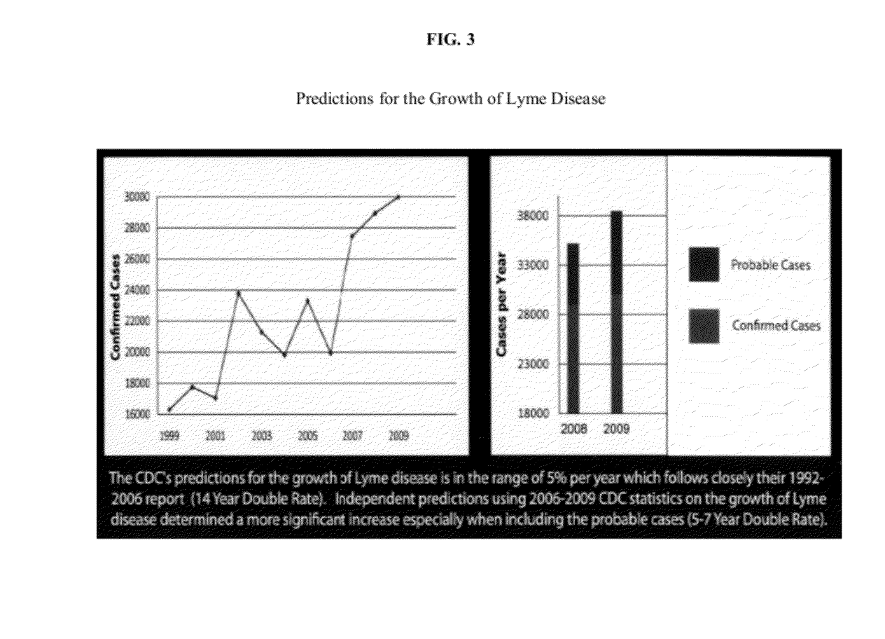

FIG. 4 is a graphical representation of the number of tick bites acquired before and after treatment with a mineral solution imprinted with an inverted tick bioelectric signal.

### DETAILED DESCRIPTION OF THE INVENTION

The growth of bug-bite related illness, including tick-borne illness, is increasing at an alarming rate. Other bugs and insects that may contribute to this growing concern relating to bug bites include, but are not limited to, mosquitoes, flies, gnats, chiggers, spiders, mites, bedbugs, lice, bees and ants. Mosquitoes, for example, can act as vectors for other serious diseases, including malaria and West Nile viral disease.

For example, the CDC study which tracked the spread of Lyme diseases from 1992-2006 found Lyme disease had doubled during the 14 year period of the study. CDC is predicting a five percent increase per year for the coming years which is very close to the data from their 1992-2006 study. However, a private and independent study of the CDC data for 2006, 2007 and 2008, which included the probable cases, predicts a much greater and more rapid doubling rate. These independently analyzed data forecast a doubling rate more in the 5-7 years range. Therefore, the predicted increase from the CDC may, in fact, be too conservative.

With that being said, Lyme disease, as well as other bug-bite related diseases, may, in fact, be increasing more rapidly than anticipated and with no immediate containment or preventative measures in place. Reducing the exposure to bug bites would slow the progress of new cases. In matters related to Lyme disease, reducing the exposure to vector ticks that carry Lyme disease would also slow the progress of outbreaks of this disease.

### Existing Repellents

Bug and insect repellents are commercially available. For example, tick repellents, both natural and chemical, that are presently in the market place were studied. The present chemical products that are popular today were found to be toxic and some have known cancer-causing agents. Many of these chemical products have questionable systemic effects. Even though these products are used by many people, these products are often avoided. The known negative effects on animals, humans and certain materials, as well as the perceived danger associated with use turns many away.

Studies of natural products found these products to function mostly by containing odors and other natural ingredients as their active ingredients. Their scent seems to be the primary component to repel ticks and many do not target ticks solely. These products seem to target mosquitoes and other bugs more than just ticks.

Disclosed herein are novel approaches to pest, bug, and insect repellent research and development, starting with strict design objectives which, in some embodiments, include: no perfume odor, either natural or chemical, no oil or greasy ingredients, and no synthetic chemicals.

### Target Organisms

In some embodiments, disclosed herein are electrically or magnetically imprintable substances comprising an electric or magnetic imprint, wherein said imprint is derived from the signature of at least one target organism. In some embodiments, the electrically or magnetically imprintable substances comprises a subtle electric or magnetic imprint, wherein said imprint is derived from the signature of at least one target organism. In some embodiments, an electric or magnetic imprint is derived from a single organism, a single species of organism, a single genus of organisms, or a single class of organisms. In other embodiments, an electric or magnetic imprint is derived from a plurality of organisms, a plurality of species of organisms, a plurality of genuses of organisms, or a plurality of classes of organisms. In various embodiments, an electric or magnetic imprint is derived from, by way of non-limiting examples, 1, 2, 10, 20, 30, 40, 50, 60, 70, 80, 90, 100, 200, 300, 400, 500, or more organisms or types of organisms, including increments therein.

Many organisms are suitable target organisms. In some embodiments, suitable target organisms are those that possess the ability to detect electric fields, magnetic fields, and/or electromagnetic fields. In further embodiments, suitable target organisms are those that further possess the ability to react to such fields by, for example, behaviors or growth patterns. Electrosense is present in many aquatic animals such as sharks, skates, rays, ratfish, lungfish, and catfish, among others. See Lon A. Wilkens & Michael H. Hofmann, Electroreception 229-63 (Theodore H. Bullock, Carl D. Hopkins, Arthur N. Popper & Richard R. Fay eds., Springer Verlag, 2005). Electrosense is also present in amphibians and mammals such as the platypus. Id. at 253-55. Animals with electrosense use this ability to help catch prey and avoid predators. Further, it has been suggested that animals with electrosense moving through the Earth's magnetic field are able to use their abilities for navigation. Id. at 235-36. An electro-sense or magneto-sense is present in non-aquatic animals as well, including mammals. Studies suggest that cattle and deer align themselves to the Earth's magnetic field when grazing. Sabine Begall, Jaroslav Cerveny, Julia Neef, Oldrich Vojtech & Hynek Burda, Magnetic alignment in grazing and resting cattle and deer 105 Proc. Nat'l Acad. Sci. U.S. 13451 (2008). Further studies have established that bats use the Earth's magnetic field to navigate. Richard A. Holland, Kasper Thorup, Maarten J Vonhof, William W. Cochran & Martin Wikelski, Navigation: Bat orientation using Earth's magnetic field, Nature, Dec. 6, 2006, at 702. Still others have shown that birds and other migratory species use magnetoception (or magnetoreception) to navigate long distances across the Earth's surface. See Wolfgang Witschko, Roswitha Witschko, Magnetic orientation in birds and other animals, 191 J. Comparative Physiology 675 (August 2008).

Studies have shown that insects also possess an electrosense. Cockroaches have been shown to avoid electrostatic fields and it is believed that their antennae and palps are crucial to their electrosense. Edmund P. Hunt, Chris W. Jackson & Philip L. Newland, “Electrorepellancy” behaviour of Periplaneta americana exposed to friction charged dielectric surfaces, 63 J. Electrostatics 853-59 (2005).

Accordingly, in various embodiments, suitable target organisms include, by way of non-limiting examples, fish, amphibians, insects, mammals, birds, and any other organisms that demonstrate an ability to detect and/or react to electric or magnetic fields. In various embodiments, suitable target organisms include, by way of non-limiting examples, members of the classes insecta, arachnida, gastropoda, nematoda, and annelida. In further embodiments, suitable members of insecta include, by way of non-limiting examples, aphids, bees, stinkbugs, beetles, weevils, cixiids, moths, tortrixes, ants, scales, borers, mosquitoes psyllids, cutworms, wasps, thrips, curculios, loopers and tuberworms. In some embodiments, suitable members of arachnida include, by way of non-limiting examples, mites, ticks, spiders, and scorpions. In some embodiments, suitable members of gastropoda include, by way of non-limiting examples, slugs and snails.

One particular embodiment includes product development approaches to tick repellents. The approach examines, for example, how the tick locates and tracks its prey. From there, methods of action for many of the odiferous products present in the market today are developed. From this research, natural elements were matched which were found, because of their composition, with similar blocking effects without any of the negatives. Mass spectrometry techniques optionally enable product developers to dial in to optimal proprietary ingredients.

Other product development approaches include, but are not limited to, products that deter, repel or eliminate insect attacks, including mosquito, mite, bee, wasp, chigger, borer, stinkbug, ant or other pest assault (including insect bites), invasion or encroachment onto a subject, object or structure.

### Electrically and Magnetically Imprintable Substances

In some embodiments, disclosed herein are electrically or magnetically imprintable substances. In one embodiment, the electrically or magnetically imprintable substances comprise an electric or magnetic imprint where an electric or magnetic field or signature is retained upon the material which has received the imprint. In further embodiments, the electrically or magnetically imprintable substances comprise an electric or magnetic imprint where a subtle electric field or magnetic field is retained upon the material which has received the imprint. In some embodiments, the substance of the composition is a natural substance that is capable of retaining information regarding a subtle electrical charge, electric field, and/or a magnetic field. In some embodiments, substances which are capable of holding signals are used as carriers for electric or magnetic imprints derived from at least one target organism.

Many substances are electrically or magnetically imprintable substances and suitable for use in the compositions and methods described herein. In various embodiments, the imprintable substances include, by way of non-limiting examples, minerals, magnetic minerals, clay minerals, sands, polymers, plastics, gemstones, gems, metallic substances, metals, silicas or liquids. In some embodiments the substances are dispersed in a liquid to form a solution or a suspension. In other embodiments, the substances are solids or powdered solids. In various embodiments, a substance includes, by way of non-limiting examples, 1, 2, 10, 20, 30, 40, 50, 60, 70, 80, 90, 100, 200, 300, 400, 500, or more natural substances or types of natural substances, including increments therein.

In some embodiments, the electrically or magnetically imprintable substance is in a purified form. In other embodiments, the electrically or magnetically imprintable substance is substantially purified. In yet other embodiments, the compositions disclosed herein comprise about 10%, about 20%, about 30%, about 40%, about 50%, about 60%, about 70%, about 80%, about 90% and about 99% of an electrically or magnetically imprintable substance. In still other embodiments, the compositions disclosed herein comprise about 1% to about 10%, about 5% to about 15%, about 10% to about 20%, about 10% to about 30%, about 10% to about 40%, about 10% to about 50%, about 10% to about 60%, about 10% to about 70%, about 20% to about 80%, about 30% to about 90%, about 40% to about 95%, about 50% to about 99%, about 60% to about 100% of an electrically or magnetically imprintable substance.

In some embodiments, the electrically or magnetically imprintable substance is a mineral. In further embodiments the mineral is solid, powdered, crystalline, or in a solution or suspension. In some embodiments, the mineral comprises any of the elements naturally contained in sea water including, but not limited to, carbon, sodium, magnesium, potassium, calcium, sulfur, lithium, boron, bromide, carbonate, fluoride, silicone, nitrogen, selenium, phosphorus, iodine, chromium, iron, manganese, titanium rubidium, cobalt, copper, antimony, arsenic, molybdenum, strontium, zinc, nickel, tungsten, scandium, tin, lanthanum, yttrium, barium, silver, uranium, gallium, zirconium, vanadium, beryllium, tellurium, bismuth, hafnium, terbium, europium, gadolinium, cerium, cesium, gold, dysprosium, samarium, holmium, lutetium, thulium, erbium, ytterbium, neodymium, praseodymium, niobium, tantalum, thorium, rhenium. In further embodiments, the mineral comprises iron. In yet other embodiments, the mineral comprises at least one metallic substance. In some embodiments, the mineral comprises at least one gemstone. In some embodiments, the gemstone is a precious gemstone, such as diamonds, rubies, emeralds, sapphires and the like. In other embodiments, the mineral is hematite.

In some embodiments, the mineral solution is a silicate mineral solution. In other embodiments, the mineral is a carbonate, sulfate, halide, phosphate, oxide, sulfide, elemental, or organic mineral solution. In other embodiments, the silicate mineral solution is a neosilicate, sorosilicate, cyclosilicate, inosilicate, phyllosilicate, or tectosilicate. In other embodiments, the silicate mineral solution is a clay mineral solution. In some embodiments, the clay mineral solution includes a kaolin mineral. In other embodiments, the clay mineral solution includes a kaolin, smectite, illite, chlorite, sepiolite, or attapulgite. In some embodiments, the kaolin mineral is kaolinite. In other embodiments the kaolin mineral is dickite, halloysite, or nacrite.

In some embodiments, the compositions described herein include an acceptable carrier. Acceptable carriers include those that facilitate the administration or application of an electrically or magnetically imprintable substance and do not block or significantly reduce the capacity of the composition to retain an electric or magnetic imprint derived from at least one target organism. In some embodiments, the carrier is water. In other embodiments, the carrier is for example, another liquid derived from a natural source. In other embodiments, the carrier is a powder.

### Modification of an Electric or Magnetic Signature

In some embodiments, disclosed herein are compositions comprising an electric or magnetic imprint. In further embodiments, the imprint is derived from at least one target organism. In still further embodiments, the imprint is a modified electric or magnetic signature derived from at least one target organisms. The electric signatures described herein are suitably modified in several ways. In some embodiments, the modification is inversion, reversal, or polarity shift of an electric field or electromagnetic field. In some embodiments, the modification is inversion, reversal, or polarity shift of an electric charge. In some embodiments, the modification is inversion, reversal, or phase shift of an electromagnetic wave. Likewise, several modifications are suitable for the magnetic signatures described herein. In some embodiments, the modification is inversion, reversal, or polarity shift of a magnetic field.

In other embodiments, the modification is amplification or reduction an electric or magnetic signature including, for example, an electric field, an electromagnetic field, an electric charge, an electromagnetic wave, or a magnetic field. In yet other embodiments, the modification is duplication an electric or magnetic signature including, for example, an electric field, an electromagnetic field, an electric charge, an electromagnetic wave, or a magnetic field.

Without being bound to a particular theory, it is hypothesized that everything in the universe oscillates or has a frequency. In some embodiments, such energy characteristics are used in the present invention. In some embodiments, an electronic device that detects the unique subtle electromagnetic frequency information of a substance is used to imprint this energy signal into a carrier substance. Those of skill in the art will recognize that many suitable devices are available. In some embodiments, such a device has an input well or plate and an output well or plate. In further embodiments, each of these wells of the device creates an electromagnetic field. The information and resonant frequencies emanating from a substance placed in the input well combines with the electromagnetic field, which then acts as a carrier wave. Therefore, the electromagnetic field captures information that is naturally emanating from the substance. In further embodiments, this magnetic field is the input to a frequency amplifier. In further embodiments, the output of the frequency amplifier is directed to the output well or plate which also has a magnetic charge. In some embodiments, the device is optionally configurable to multiple modes, for example, duplication and inversion. In further embodiments, one can change the setting of the equipment to duplicate the substance from the input well and amplify it into the substance in the output well. In still further embodiments, also by again changing the setting of such equipment one may choose to invert the resonant frequency and thus the substance in the output well will receive the output inverted resonant frequency.

In some embodiments disclosed herein, a modified electric or magnetic signature is imprinted (e.g., adhered, recorded, stored, etc.) to an electrically or magnetically imprintable substance. Imprinting is suitably achieved via a variety of methods. In some embodiments, the electrically or magnetically imprintable substance is surrounded by the modified electric or magnetic signature. In other embodiments, the electrically or magnetically imprintable substance is immersed in the modified electric or magnetic signature. In yet other embodiments, the electrically or magnetically imprintable substance is exposed to the modified electric or magnetic signature. Many durations of exposure are appropriate. In various embodiments, an electrically or magnetically imprintable substance is exposed for 1, 2, 3, 4, 5, 6, 7, 8, 9, 10, 20, 30, 40, 50, 60, 70, 80, 90, or more seconds, including increments therein. In other various embodiments, an electrically or magnetically imprintable substance is exposed for 1, 2, 3, 4, 5, 6, 7, 8, 9, 10, 20, 30, 40, 50, 60, 70, 80, 90, or more minutes, including increments therein. In yet other embodiments, an electrically or magnetically imprintable substance is exposed for 1, 2, 3, 4, 5, 6, 7, 8, 9, 10, 20, 30, 40, 50, 60, 70, 80, 90, or more days, including increments therein.

In one embodiment, the electrical or magnetic imprint is derived from an insect or bug. The methods first employs the identification of at least one target organism or a plurality of target organisms. Once the target organism, i.e. bug (or bugs) or insect (or insects), are identified and analyzed, in some embodiments a bioelectrical inversion and/or modification of the bug or insect may be tested to determine efficacy in the elimination of patient test responses. Such testing may comprise the use of libraries or matrices to store the bioelectrical inversion or modification of the target bug or insect. Final treatment may consist of application of a bioelectrical or bioresonant inversion and/or modified footprint of the target organism (i.e., bug or insect). The resultant matching bug or insect inverted or modified bioelectric signal is then adhered to an appropriate carrier for eventual administration.

Other methods for altering the attraction, or repelling target organisms, including insect(s) or bug(s), includes the altering of resistance values by including the application of electromagnetic signals to the individual, disclosed in U.S. Patent Application Pub No. 2009/0196582, filed Feb. 4, 2009, which is incorporated by reference herein in its entirety. Such electromagnetic signals can be generated through the measurement of resistance values upon application of a defined electrical and magnetic energy to an individual. U.S. Pat. No. 6,142,297, which is incorporated by reference herein in its entirety, describes one means of defining and administering an electrical and magnetic signal, including the use of a computer generated binary value to define a resonant signal.

### Mode of Action

In some embodiments, disclosed herein are compositions of electrically or magnetically imprintable substances comprising an electric or magnetic imprint, wherein said imprint is a modified electric or magnetic signature derived from at least one target organism. In some embodiments, the composition protects a subject organism, plant, animal, or an object or structure from detection by one or more target organisms.

In some embodiments, the compositions disclosed herein alter the detectable electrical properties of a subject, object or structure to which they are applied. In some embodiments, the composition, when applied to a subject, object or structure, alters the electric field of (e.g., around) the subject, object or structure. In further embodiments, the composition, when applied to a subject, object or structure, decreases the electric field of the subject, object or structure. See, e.g., Example 2, infra. In further embodiments, the composition, when applied to a subject, object or structure, alters the electrical impedance of the subject, object or structure. In further embodiments, the composition, when applied to a subject, object or structure, increases the electrical impedance of the subject, object or structure. See, e.g., Example 2, infra.

In some embodiments, such alterations in electrical and/or magnetic properties of a subject, object or structure affects the ability of a target organism to detect, sense, or track the subject, object or structure. In further embodiments, such alterations in electrical and/or magnetic properties of a subject, object or structure reduces, impedes, and/or blocks the ability of a target organism to detect, sense, or track the subject, object or structure. In a particular embodiment, such alterations in electrical and/or magnetic properties render the subject, object or structure undetectable to the electrosense or magnetosense of a target organism.

In some embodiments, the electrical and/or magnetic properties of a subject, object or structure are measurably detected. In some embodiments, the electrical and/or magnetic properties of a subject, object or structure is altered by about 10%, by about 15%, by about 20%, by about 25%, by about 30%, by about 35%, by about 40%, by about 45%, by about 50%, by about 55%, by about 60%, by about 65%, by about 70%, by about 75%, by about 80%, by about 85%, by about 90%, by about 95%, by about 99% or by about 100%. In some embodiments, the electrical and/or magnetic properties of a subject, object or structure is altered by about 10% to about 100%, by about 10% to about 90%, by about 10% to about 80%, by about 10% to about 70%, by about 10% to about 60% by about 10% to about 50%, by about 20% to about 100%, by about 20% to about 80%, by about 20% to about 60%, by about 30% to about 70%, by about 30% to about 60%, by about 30% to about 50%, by about 40% to about 100%, by about 40% to about 90%, by about 40% to about 80%, by about 40% to about 70%, by about 40% to about 60%, by about 50% to about 100%, by about 50% to about 90%, by about 50% to about 80%, by about 50% to about 70%, by about 60% to about 100%, by about 60% to about 90%, by about 60% to about 80%, by about 70% to about 100% or by about 80% to about 100%.

### Human and Veterinary Uses

In some embodiments, the composition administered may be an injectable composition, oral composition, or a topical composition. In some embodiments, the composition is applied topically to a subject, which suitably includes humans, non-human animals, and any other organism that is beneficially protected from a target organism. In further embodiments, topical formulations include ointments, lotions, pastes, creams, gels, hydrogels, drops, suppositories, sprays, aerosols, liquids, shampoos, powders, antiperspirants, deodorants, rinses, soaps, or are incorporated into topical make-up products, including but not limited to face power, foundation, rouge, eye shadow, mascara, eyeliner or lipstick, UV-protective products, which may include sunscreens, lotions or creams, transdermal patches, and wipes. In still further embodiments, the topical composition further comprises one or more excipients including, by way of non-limiting examples lubricants, thickeners, emollients, moisturizers, spreading agents, rheology modifiers, emulsifiers, dispersing agents, and binders. In particular embodiments, the excipients are natural, non-synthetic, and/or organic.

In some embodiments, one function of the carrier is to enhance skin penetration of the active ingredient(s), and should be capable of delivering an imprinted electric or magnetic signature under in vivo conditions. Suitable carriers are well known to skilled practitioners, and include liposomes, ethanol, dimethylsulfoxide (DMSO), petroleum jelly (petrolatum), mineral oil (liquid petrolatum), water, dimethylformamide, dekaoxyethylene-oleylether, oleic acid, 2-pyrrolidone and Azone® brand penetration enhancer (Upjohn). In some embodiments, the composition is all-natural, organic, green, has a low carbon footprint, environmentally friendly, and eco-conscious.

The inventions disclosed herein include products that may be worn by a subject. In some embodiments, the electric and/or magnetic imprints are applied (e.g., adhered, recorded, stored, etc.) to jewelry or other accessories, which may be worn by a human or a non-human animal seeking to avoid detection by a target animal, insect, or pest. In some embodiments, solutions of electrically or magnetically imprintable substances are used to treat, for example, construction material, such as drywall, beams, windows, flooring, light fixtures, insulation, paint, plaster, roofing material, concrete and the like, and paper, textiles or the like. In further embodiments, treating a textile with an electrically or magnetically imprintable liquid or a solution of an electrically or magnetically imprintable substance imparts an electric or magnetic imprint (or modification thereof) derived from at least one target organism to the textile. In a particular embodiment, the electric or magnetic imprint is applied to diving equipment to help divers avoid detection from aquatic organisms, such as sharks. In some embodiments, a structure, such as a house, fence, wall, ornamental object and the like, are treated with a liquid or a solution of an electrically or magnetically imprintable substance. In yet other embodiments, manufacturing processes for construction material, paper, textiles or the like include the pre-treatment or treatment of these materials with a liquid or a solution of an electrically or magnetically imprintable substance.

### Agricultural Uses

In some embodiments, the composition is applied topically to animals, such as domesticated animals and livestock which may benefit from being undetected by one or more target animals, insects, or pests. In other embodiments, the composition is applied to crops or plants which are harmed by animals, insects, or pests and would benefit from being undetected by the like. Accordingly, the inventions disclosed herein include products that are applied to plants or crops as a pest deterrent. In other embodiments, the composition is a mineral solution (e.g., a kaolinite solution, etc.) imprinted with an electrical or magnetic signal or frequency derived from at least one target organism, that is then applied directly to the plant or crop. In some embodiments, seeds, pods, flowers, fruit and other agricultural products are impregnated with the composition.

### Mode of Administration

In some embodiments, the compositions disclosed herein may be applied to the subject, object or structure on a long-term, chronic basis. In one embodiment, the compositions disclosed herein are applied once-daily, twice-daily, three-times daily, four-times daily or as needed, on a daily, weekly, monthly or bi-monthly basis. Depending upon the strength of the magnetically or electrically imprinted signal or frequency onto the magnetically or electrically imprintable substances, the compositions disclosed herein may alternatively be applied infrequently. By way of example only, the compositions disclosed herein may be applied on an annual or bi-annual basis.

In some embodiments, the compositions disclosed herein are used continuously. In other embodiments, the compositions disclosed herein may be temporarily suspended or halted for a set period of time. The length of the suspension varies between 2 days and 1 year, including by way of example only, 2 days, 3 days, 4 days, 5 days, 6 days, 7 days, 10 days, 12 days, 15 days, 20 days, 28 days, 35 days, 50 days, 70 days, 100 days, 120 days, 150 days, 180 days, 200 days, 250 days, 280 days, 300 days, 320 days, 350 days, and 365 days. In addition, the amount of compositions may be reduced from 10%-100%, including by way of example only 10%, 15%, 20%, 25%, 30%, 35%, 40%, 45%, 50%, 55%, 60%, 65%, 70%, 75%, 80%, 85%, 90%, 95%, and 100%.

In some embodiments, substantially all of the targeted organisms are repelled or blocked by the compositions disclosed herein. In other embodiments, about 10%, about 20%, about 30%, about 40%, about 50%, about 60%, about 70%, about 80% or about 90% of the target organisms are repelled upon administration of the magnetically or electrically imprinted compositions. In yet other embodiments, a significant reduction in pest occurrence, including reduction in bites or other physical manifestations of the pest, or physical reduction of the number or types of pests present, is achieved.

### Commercialization

The inventions disclosed herein include business methods. In some embodiments, the scalability of the techniques and methods disclosed herein are utilized to design, build, and operate industrial and/or commercial facilities for production of a pest repellent. In further embodiments, pest repelling topical lotions, creams, ointments, hydrogels, aerosols, or sprays are produced, stored, distributed, marketed, advertised, and sold as consumer products or sold to large organizations such as the United States Military. In other embodiments, the techniques and methods disclosed herein are utilized to design, build, and operate industrial and/or commercial facilities for production of agricultural pest insect repellents. In further embodiments, pest repelling liquids or clays are produced, stored, distributed, marketed, advertised, and sold as commercial insecticides for consumer and industrial agriculture. In other embodiments, the techniques and methods disclosed herein are utilized to design, build, and operate industrial and/or commercial facilities for production of items that may be worn in order to repel pests. In further embodiments, pest repelling jewelry, gems, or other accessories are produced, stored, distributed, marketed, advertised, and sold as consumer products or sold to large organizations. In other embodiments, the techniques and methods disclosed herein are utilized to design, build, and operate industrial and/or commercial facilities for production of clothing that may be worn in order to avoid detection from pests. In further embodiments, pest repelling treated textiles are produced, stored, distributed, marketed, advertised, and sold as consumer products or sold to large organizations. In other embodiments, the techniques and methods disclosed herein are utilized to design, build, and operate industrial and/or commercial facilities for production of equipment used to avoid detection from electrosensing animals such as sharks. In further embodiments, wetsuits, vests, and other diving equipment are produced, stored, distributed, marketed, advertised, and sold as consumer products or sold to large organizations.

### EXAMPLES

The following specific examples are to be construed as merely illustrative, and not limitative of the remainder of the disclosure in any way whatsoever. Without further elaboration, it is believed that one skilled in the art can, based on the description herein, utilize the present invention to the fullest extent.

### Example 1

### Preparation of Imprintable Substances

A tick, or bioelectric imprint of a tick, is placed in the input well or plate of a Med-Tronik ZVST-Ā (Med-Tronik GmbH, Frisenheim, Germany), and in the output well 8-16 oz. mineral solution (ProCell, HealthTech, Utah). The ZVST-Ā device is set to inversion and no amplification or magnification of the signal. Exposure of the mineral solution to the imprint signal occurs for up to 21 minutes. The imprinted mineral solution is shaken vigorously before use.

### Example 2

### Pilot Testing of Tick Repellent

A two-year field trial was performed with a small number of subjects in locations where daily tick sightings and bites were common. The goal was to determine product effectiveness and user friendliness. The composition was supplied to all test subjects and all subjects reported tick sightings and bites to a single study coordinator. After test subjects used the trial product during high tick seasons over a two-year period, the trial coordinator summarized the results of the test in a questionnaire.

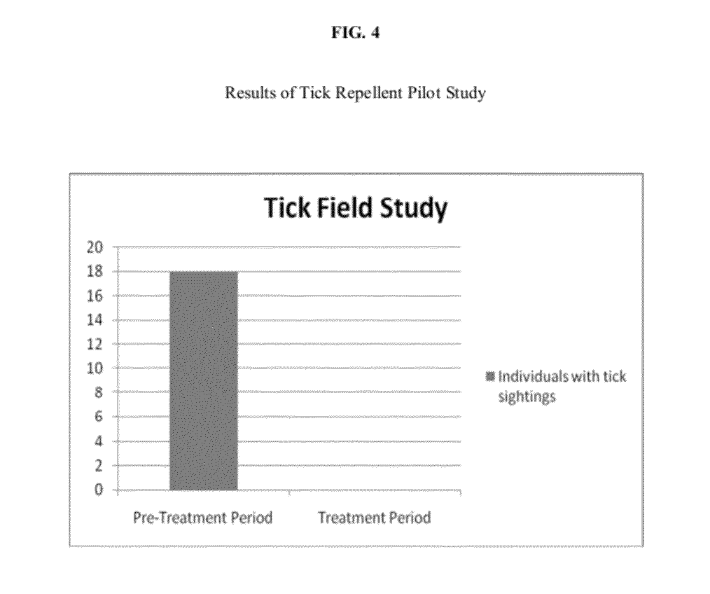

The three families of six subjects each ranged in age from infants to adults in their forties. All age groups; infants, preteen, teens and adults responded equally. No ticks were found on the bodies of any of the test subjects and no tick bites were reported by any of our test subjects. See FIG. 4. This was in contrast to their prior experiences in the areas where multiple sightings and bites had previously occurred.

With the success of the field trial data, larger formalized clinical trials are planned. Subjects who have significant tick exposure are desired to adequately test the effectiveness of the trial product. All subjects will be using the same trial product and no control non acting substances will be used. Product will be provided to qualifying subjects for the duration of the clinical trials.

### Example 3

### Electrical Properties and Laboratory Testing

Studies were conducted to investigate the effects of a composition disclosed herein on the electrical fields of human subjects when applied to the skin of the subject. These studies were conducted to determine any detectable changes in the electric field, light emission, conductance, and blood flow of a human subject pre and post application of the test composition. The studies were performed in a university laboratory room which was kept at a constant temperature of about 70° F., except for the Bio Impedance test, which was performed at 75° F.

### Decreasing Electric Field

The first test determined if application of the composition affected the electric fields around the human body. In order to determine this, an AlphaLab Electrostatic Meter with a chopper-stabilized sensor was used and the following measurements were performed:
1. The reading of the electric field meter was allowed to stabilize.
2. Values were recorded just before the subject put the top of his hand one inch away from the sensor.
3. Values were then recorded after the subject put the top of his hand one inch below the sensor and after the value stabilized.
4. Steps 2 and 3 were repeated after the composition was applied to the top of the hand and also repeated with subject grounded and not grounded.

The results are shown in Table 1. “No arm” indicates measurements of the electric field naturally present in the room, while “Arm” indicates measurements of the electric field when the arm of the subject was placed below the sensor.

TABLE 1
Electric Field Measurement Results

| | Before Spraying (V) | | | After Spraying (V) | | |
|---|---|---|---|---|---|---|
| | No Arm | Arm | Abs. Diff | No Arm | Arm | Abs. Diff |
| Grounded | 8.5 | 2.3 | 6.2 | 7.9 | 7.2 | 0.7 |
| Not Grounded | 17.3 | 10.3 | 7.0 | 9.0 | 8.3 | 0.7 |

As is shown by Table 1, the results of applying the composition decreased the person's electrical field by a factor of 10. Grounding the subject did not have a significant impact. It has been established that certain insects have electrical field sensing capabilities. It therefore follows that a reduction in electrical field results in a reduced electrical visibility to such insects. In fact, a 10-fold decrease in electrical field makes a person significantly less electrically visible and almost to the point of blending in with naturally occurring background fields, rendering the subject virtually “invisible” to the insect's electrical visibility.

### Biophoton Measurements

The second test measured the discrete photons emitted from the subject's palm and analyzed its patterns. A Mamamatsu Photomultiplier Tube Model H6180-01 Photon Counting Head, Fluke Model PM6690 Counter/Analyzer, and Fluke Time View 90W Software were used and the following steps were performed:
1. Photon emission was measured without the subject's hand for 1 minute.
2. Photon emission was measured with the subject's hand for 1 minute.
3. The composition was applied to the subject's hand and photon emission was measured for 1 minute.

The results are shown in Table 2. Results were measured in counts per second for the 1 minute of measurement and the standard deviation was 0.5 cps for all measurements.

TABLE 2
Biophoton Emission Results in counts per second (cps)

| | Emission | Change |
|---|---|---|
| | (cps) | (cps) |
| Background | 13.3 | |
| Hand no spray | 28.8 | 15.5 |
| Sprayed hand | 34.3 | 21.0 |

Biophoton emission was increased by about 5 cps after application of the compound, which is much higher than the standard deviation of the biophoton measurements. Biophoton emission increases when there is a change in blood flow causing an increase in skin temperature or there is a change in local properties of the skin.

### Testing Blood Flow and Skin Temperature

Blood flow was measured in order to explain the increase in biophoton emission. If there is no change in blood flow, there is no change in skin temperature, and therefore the reason for the increase in biophoton emission is due to a change in local properties of the skin.

Blood flow was measured using a Moor DRT4 laser Doppler perfusion monitor. The laser Doppler technique is a unique method for continuous monitoring of tissue blood perfusion. It can be used for registering dynamic or evolving responses to blood flow in the capillaries, venules, and arterioles responsible for nutrition of the skin and thermoregulation.

The sensor was placed about midway between the elbow and the wrist on the dorsal portion of the forearm of the subject. There was no noticeable change in the blood flow seen with the monitor, leading one to conclude to that there is no increase in skin temperature. Therefore, the only explanation for increase in biophoton emission is a change in local properties of the skin.

### Bio Impedance Analysis

When the composition was applied to the subject during this test, the subject was sprayed from head to foot with the composition and allowed to air dry before the test was conducted. The following steps were performed:
1. A measurement was taken before any of the composition was applied.
2. A measurement was taken of the subject's right half of the body, which is the side of the recording leads, after being sprayed at 25% dilution.
3. A measurement was taken of the subject sprayed with a 25% solution of the whole body, except under the recording leads.
4. A measurement was taken of the subject sprayed with a full strength solution of the whole body.
5. A measurement was taken of the subject after being sprayed and air dried just under the leads where the skin had been protected in prior measurements.

The results are shown in Table 3.

TABLE 3
Bio Impedance Measurements

| Measure | Resistivity |
|---|---|
| 1st Measure | 552/66 |
| 2nd Measure | 560/63 |
| 3rd Measure | 571/64 |
| 4th Measure | 578/63 |
| 5th Measure | 578/63 |

The results of the testing demonstrate a consistent increase in resistance as more of the composition was applied to the subject. Notably, there is also no change in resistivity resulting from spraying under the recording leads, which is interpreted as an indication the effects were systemic and not localized to just the area of the measurement. This change in resistance of the skin after application of the composition is consistent with a change in dielectric properties of the skin and cannot be explained by an increase in skin temperature.

Application of the composition reduces a person's electric field by a factor of 10. Since there was no change in blood flow, biophoton emission results lead one to conclude that application of the composition produces a change in local electrical properties of the skin. This conclusion is further reinforced by bio-impedance measurements which showed an increase in resistance resulting in a decrease of body conductance as a result of the application of the composition.

### Example 4

### Volatile and Semi-Volatile Organics Testing

The imprinted mineral solution of Example 1 was tested for volatile organics using GC/MS analysis (Method 8260C (ALS SOP OV0SW08260C Revision 1), ALS, Salt Lake Utah). The five point minimum initial calibration curve was analyzed prior to sample analysis. A calibration verification standard (CVS) which is used in the validation of the initial calibration was also analyzed prior to sample analysis. The CVS met the method criteria as specified. A maximum of 20% of percent difference (percent drift for alternate curve fits) values may exceed a 20% limit based on the initial calibration curve.

A GC/MS method for determination of semivolatile organic compounds in water according to the SW-486 Guidelines was also performed. One liter of sample was extracted by reparatory funnel and then concentration to a final volume of 1.0 ml. The resulting extract was analyzed using an Agilent model 5973 GC/MS system with an electron impact ionization source and a quadrapole mass-filter detector. A six-point initial calibration curve was analyzed prior to sample analysis.

RESULTS: The volatile organic analysis detected acetone at approximately 65,000 μg/L. No other volatile organic compounds were detected. The semi-volatile organic analysis detected benzoic acid at approximately 130,000 μg/L. The only other compound detected was sorbic acid at approximately 13,000 μg/L.

### Example 5

### Using Composition to Deter Pests on Crops

A farmer wishes to protect a 40-acre corn crop from corn leaf aphids (Rhopalosiphum maidis). A sample of approximately 1000 such aphids is obtained. The electromagnetic field signature of the sample of aphids is obtained. The signature is then modified by inversion (e.g., phase shift of an electromagnetic wave). The composition is then created by imprinting the modified signature onto an aqueous kaolinite mineral solution. The composition is sprayed onto the crop of corn at two different points in the growing cycle. Application of the composition reduces the strength of the detectable electric field of the corn plants. Corn leaf aphids are unable to sense or recognize the electrical field of the corn as being distinct from the electrical field of the surroundings. The corn is effectively invisible to the aphids; therefore, the corn is substantially protected against the aphids. Additionally, corn seed is impregnated with the composition carrying the modified imprints of the plurality of aphids.

While preferred embodiments of the present invention have been shown and described herein, it will be obvious to those skilled in the art that such embodiments are provided by way of example only. Numerous variations, changes, and substitutions will occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A composition comprising: an electrically or magnetically imprintable substance comprising an electric or magnetic imprint, wherein said imprint is a modified electric or magnetic signature derived from at least one target organism; and an acceptable carrier.

2. The composition of claim 1, wherein the composition, when applied to a subject, decreases the electric field of the subject.

3. The composition of claim 1, wherein the composition, when applied to a subject, increases the electrical impedance of the subject.

4. The composition of claim 1, wherein the electrically or magnetically imprintable substance is a mineral, a mineral powder or a mineral solution.

5. The composition of claim 4, wherein the mineral comprises iron, a clay mineral or a kaolinite mineral.

6. The composition of claim 1, wherein the electrically or magnetically imprintable substance is a polymer.

7. The composition of claim 1, wherein the carrier is substantially water.

8. The composition of claim 1, wherein the at least one target organism is chosen from the group consisting of: insecta, arachnida, gastropoda, nematoda, and annelida.

9. The composition of claim 8, wherein the at least one target organism is chosen from the group consisting of: ticks, mosquitoes, flies, gnats, cockroaches, stink bugs, chiggers, spiders, mites, bedbugs, lice, bees, and ants.

10. The composition of claim 1, wherein the modification to the electric or magnetic imprint is selected from the group consisting of: inversion, reversal, phase shift, polarity shift, amplification, and duplication.

11. The composition of claim 1, wherein the composition is a topical composition.

12. A method to repel at least one target organism from a subject, the method comprising: administering to the subject a composition comprising an electrically or magnetically imprintable substance comprising an electric or magnetic imprint, wherein said imprint is a modified electric or magnetic signature derived from the at least one target organism; and an acceptable carrier.

13. The composition of claim 12, wherein the composition, decreases the electric field of the subject or increases the electrical impedance of the subject.

14. The composition of claim 12, wherein the electrically or magnetically imprintable substance is a mineral, a mineral powder or a mineral solution.

15. The composition of claim 14, wherein the mineral comprises iron, a clay mineral or a kaolinite mineral.

16. The composition of claim 12, wherein the electrically or magnetically imprintable substance is a polymer.

17. The composition of claim 12, wherein the carrier is substantially water.

18. The composition of claim 12, wherein the at least one target organism is chosen from the group consisting of: insecta, arachnida, gastropoda, nematoda, and annelida.

19. The composition of claim 18, wherein the at least one target organism is chosen from the group consisting of: ticks, mosquitoes, flies, gnats, cockroaches, stink bugs, chiggers, spiders, mites, bedbugs, lice, bees, and ants.

20. The composition of claim 12, wherein the modification to the electric or magnetic imprint is selected from the group consisting of: inversion, reversal, phase shift, polarity shift, amplification, and duplication.
